(19) United States
(12) Patent Application Publication
(10) Pub. No.: US 2010/0212761 A1
(43) Pub. Date: Aug. 26, 2010

(54) Sanitary Water Outlet with a Ball and Socket Joint

(75) Inventor: Keith HART, Welland (GB)

Correspondence Address: CROWELL & MORING LLP;INTELLECTUAL PROPERTY GROUP, P.O. BOX 14300, WASHINGTON, DC, 20044-4300, US

(73) Assignee: Neoperl GmbH, Muellheim (DE)

(21) Appl. No.: 12/693,012

(22) Filed: Jan. 25, 2010

(30) Foreign Application Priority Data
Feb. 20, 2009 (DE) 102009009865.8-25

(51) Int. Cl. F16K 21/00

(52) U.S. Cl. 137/801

(57) ABSTRACT

A sanitary water outlet has at least two ball-and-socket joints, each of which comprises a socket and a spherical part pivotably held therein which have mutually connected water conduits. The outer circumference of the socket of one ball joint is formed as the spherical part of the adjacent ball joint. The action radii of the at least two mutually connected ball joints are added to one another and therefore provide a significantly enlarged action radius. Because the socket of one ball joint is constructed on its outer circumference at the same time as the spherical part of the adjacent ball joint, the water outlet according to the invention has a comparatively low overall height.

### BACKGROUND AND SUMMARY OF THE INVENTION

This application claims the priority of German patent application 10 2009 009 865.8-25, filed Feb. 20, 2009, the disclosure of which is expressly incorporated by reference herein.

The present invention relates to a sanitary water outlet having a ball-and-socket joint in which a socket and a spherical part pivotably held therein have mutually connected water conduits.

When a sanitary outlet fitting is opened, the jet direction of the water jet flowing out of the water outlet is normally defined by the jet-conducting inner circumference of the outlet fitting. Because a water jet that deviates from the defined direction of the jet may be useful in certain applications, sanitary water outlets of the initially mentioned type have been developed, which have a ball-and-socket joint with a socket and a spherical part pivotably held therein, in which mutually connected water conduits are provided. By means of such a water outlet (also abbreviated as “ball joint”), the flowing-out water jet can be deflected from the predefined jet direction and can be diverted into a required direction.

Such water outlets comprising ball joints are offered in serial form, particularly in the case of bidet fittings, or usually as a separate component or accessory part which can also be mounted subsequently on the outlet end of a sanitary outlet fitting. Although such components and accessory parts provide an enlarged action radius for handling a sanitary outlet fitting, because the spherical part is held in the socket, and because during the pivoting of the spherical part in the socket the outlet-side conduit opening of the water conduits must be kept free, the pivoting range between the spherical part and the socket is ultimately limited. If, on the contrary, a greater action radius is required (for example, in the case of sinks) flexible outlet hoses must be used. The latter, however, may reduce the distance between the outflow side outlet orifice and the sink in such a manner that this distance is frequently hardly sufficient for example, to permit placing a jug in-between that is to be filled with water.

It is therefore an object of the present invention to create a sanitary water outlet of the initially mentioned type which, without further significant restrictions, provides the user with an enlarged action radius in the form of an enlarged pivoting angle.

This and other objects and advantages are achieved by the sanitary water outlet according to the invention, which has at least two mutually connected ball joints with mutually connected water conduits. The outer circumference of the socket of one ball joint is further developed as the spherical part of the adjacent ball joint.

The action radii of the at least two mutually connected ball joints are added to one another, and can therefore provide the user with a significantly enlarged action radius. Because the outer circumference of the socket of one ball joint also forms the spherical part of the adjacent ball joint, the water outlet according to the invention is nevertheless characterized by a comparatively low overall height. In this case, the water outlet according to the invention may be fixedly mounted to the outlet end of a sanitary water pipe or preferably can be detachably fastened as a separate component or accessory part to a sanitary outlet fitting. In this case, it does not matter whether the water outlet is held on the water pipe or on the outlet fitting by means of the socket or by means of the spherical part of one of its ball joints.

In a preferred and particularly space-saving embodiment, the ball joints are implemented in one another.

In order to also retrofit a sanitary outlet fitting, if required, with the water outlet according to the invention, it is advantageous for the water outlet to be detachably connectable to the outlet end of a sanitary outlet fitting.

In a preferred embodiment of the invention, the spherical part of each ball joint is arranged on the inflow side and its socket is arranged on the outflow side. In this embodiment, the cross-sectional area of flow can expand in the direction of the outlet end, and reductions of the cross-sectional area and flow obstacles impairing the flow pattern are avoided.

Since sanitary outlet fittings normally carry a thread on their outlet end, onto which thread an outlet nozzle can be mounted for receiving a jet regulator or a jet shaper, the exchange for a water outlet according to the invention is significantly facilitated if the spherical part of the inflow side ball joint is connected preferably in one piece with a threaded bush intended for the connection to an outlet fitting, which threaded bush has an external thread and/or an internal thread.

Even in the case of such an exchange (of the outlet nozzle for the water outlet according to the invention) the functionality will not be further impaired if a jet regulator is provided on the outflow side joint part of the outflow side ball joint, to which jet regulator, as required, a flow rate regulator or a flow rate limiting device may be connected on the input side in the flow direction.

Other objects, advantages and novel features of the present invention will become apparent from the following detailed description of the invention when considered in conjunction with the accompanying drawings.

### BRIEF DESCRIPTION OF THE DRAWINGS

FIG. 1 is a longitudinal sectional view of a sanitary water outlet having two mutually interacting ball joints, which water outlet can be detachably mounted as a separate component or accessory part at the outlet end of a sanitary outlet fitting (not shown);

FIG. 2 is a top view of the inflow side of the water outlet from FIG. 1;

FIG. 3 is a longitudinal sectional view of the water outlet of FIGS. 1 and 2, in an angled pivoting position of one of its ball joints;

FIG. 4 is a top view of the inflow side of the water outlet from FIGS. 1 to 3 in the pivoting position illustrated in FIG. 3;

FIG. 5 is a longitudinal sectional view of the water outlet in the pivoting positions of its mutually interacting ball joints; and

FIG. 6 is a top view of the inflow side of the water outlet from FIGS. 1 to 5 in the pivoting position illustrated in FIG. 5.

### DETAILED DESCRIPTION OF THE INVENTION

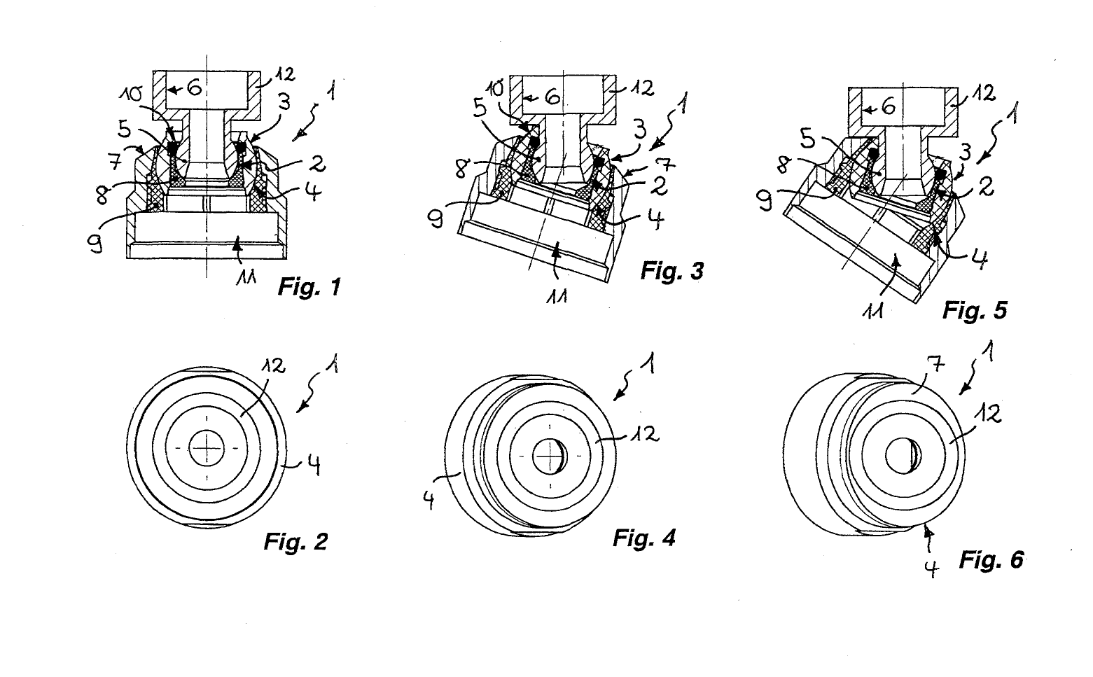

FIGS. 1 to 6 illustrate a sanitary water outlet 1 which has at least two mutually connected ball joints. Since the outer circumference of the socket 2 of one ball joint is formed as a spherical part 3 of the adjacent ball joint, whose socket 4, in turn, reaches around the spherical part 3, the water outlet 1 is nevertheless characterized by a comparatively short overall length.

The water outlet 1 may be fixedly mounted on the outlet end of a sanitary water pipe or—as in this case—may be detachably mountable as a separate component or accessory part on a sanitary outlet fitting. For this purpose, the spherical part 5 of the inflow side ball joint is connected in one piece with a threaded bush 12 which, for the connection to an outlet fitting, carries an external thread or an internal thread provided in area 6.

A comparison of FIGS. 1, 3 and 5 shows that it does not matter per se whether the water outlet 1 is held by means of the socket 4 or by means of the spherical part 2 of one of its ball joints on the water pipe or outlet fitting. However, so that the cross-sectional area of flow can expand in the direction of the outlet end, and so that the jet pattern is not impaired by cross-sectional reductions or flow obstacles, the spherical part 5, 3 of each ball joint is arranged on the inflow side and its socket 2, 4 is arranged on the outflow side. In this case, a first ball joint arranged on the inflow side is formed by the joint parts 2, 5 and a second ball joint arranged on the outflow side is formed by the joint parts 3, 4, these joint parts 2, 3, 4, 5 having mutually connected water conduits.

While, in FIGS. 3 and 4, only one of the ball joints of the water outlet 1 is in a pivoting position, in FIGS. 5 and 6, both ball joints are each in their pivoting position. A comparison of FIGS. 3 and 5 shows that the action radii of the ball joints are added to one another and can therefore provide the user with a significantly enlarged action radius.

In this case, a bevel 7 or an inclination is provided on the inflow side outer-circumferential edge area of the outflow side ball joint, which bevel 7 or inclination rests on the outflow side face of the adjacent threaded bush 5 in the maximal pivoting position of the water outlet illustrated in FIG. 5.

It is illustrated in FIGS. 1, 3 and 5 that the sockets 2, 4 are further developed in two parts and have a socket interior part 8, 9 produced from a lower-friction material, particularly a synthetic material. A sealing ring 10 is provided in the boundary area arranged between the spherical part 5 and the socket 2, which sealing ring 10 seals off the space against undesirable leakage flows.

A comparable sealing ring or similar sealing device may also be provided in the boundary area between the spherical part 3 and the socket 4. Since sanitary outlet fittings normally carry a thread on their outlet end, on which thread an outlet mouthpiece for receiving a jet regulator or a jet shaping device can be mounted, an exchange for the water outlet illustrated here can easily take place. In order to avoid impairing the functionality even in the case of such an exchange, a jet regulator (not shown) may be provided on the outflow side joint part 4 of the outflow side ball joint, to which jet regulator, as required, a flow rate regulator or a flow rate limiting device is connected on the input side in the flow direction. For this purpose, the outflow side joint part formed by the socket 4 has an inside cavity 11 open on the outflow side, into which a jet regulator can be inserted from the outlet face.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A sanitary water outlet having a ball-and-socket joint, which has a socket and a spherical part pivotable relative to the socket and held therein, which have mutually connected water conduits; wherein:
the water outlet has at least two mutually connected ball joints;
an outer circumferences of the socket of one ball joint is formed—as the spherical part of the adjacent ball joint; and
joint parts of the ball joints have mutually connected water conduits.

2. The water outlet according to claim 1, wherein the water outlet is detachably connectable to an outlet end of a sanitary outlet fitting.

3. The water outlet according to claim 1, wherein the spherical part of each ball joint is arranged on an inflow side and its socket is arranged on an outflow side.

4. The water outlet according to claim 1, wherein:
the spherical part of the inflow side ball joint is connected preferably in one piece with a threaded bush for connection to an outlet fitting; and
the threaded bush has one of an external thread and an internal thread.

5. The water outlet according to claim 1, wherein a jet regulator is provided on an outflow side joint part of the outflow side ball joint; and
one of a flow rate regulator and a flow rate limiting device is connected to the jet regulator on the input side in the flow direction.

6. A water outlet assembly comprising:
an inflow element adapted to be detachably coupled to an outlet of a water supply;
an outflow element;
a first ball and socket joint; and
a second ball and socket joint; wherein,
said first ball and socket joint is enclosed within one of said inflow element and said outflow element;
said second ball and socket joint is nested within said first ball and socket, with an outer surface of said second ball and socket joint forming a ball portion of said first ball and socket joint;
mutually connected water conduits through said first and second ball joints form a flow path between said inflow and outflow elements.

7. The water outlet assembly of claim 6, wherein a jet regulator is provided on said outflow element.
